(19) United States
(12) Patent Application Publication
(10) Pub. No.: US 2011/0181289 A1
(43) Pub. Date: Jul. 28, 2011

(54) LOCATOR ASSEMBLY FOR DETECTING, LOCATING AND IDENTIFYING BURIED OBJECTS AND METHOD OF USE

(75) Inventor: William C. Rushing, Sun Prairie, WI (US)

(73) Assignee: Berntsen International, Inc., Madison, WI (US)

(21) Appl. No.: 13/015,047

(22) Filed: Jan. 27, 2011

Related U.S. Application Data
(60) Provisional application No. 61/298,733, filed on Jan. 27, 2010.

(51) Int. Cl. G01V 3/08

(52) U.S. Cl. 324/326

(57) ABSTRACT

A locator assembly for the detection, location and identification of a buried object is provided comprising a sensor portion adapted to detect and measure the magnetic field strength of a buried object. A control assembly is connected to the sensor portion, wherein the control assembly is adapted to receive and analyze the magnetic field strength provided by the sensor portion to ascertain the location of a buried object. An identification portion is connected to the control assembly and operates independent of the sensor portion, wherein the identification portion is adapted to communicate with the buried object to ascertain the identity of the buried object. A method for the detection, location and identification of a buried object is also provided.

### CROSS-REFERENCE TO RELATED APPLICATIONS

This application claims priority from U.S. Provisional Application Ser. No. 61/298,733, filed Jan. 27, 2010, entitled UNIVERSAL READER AND SYSTEM FOR LOCATING AND IDENTIFYING BURIED OBJECTS AND UTILITY INFRASTRUCTURE, the contents of which is hereby incorporated in their entirety by reference.

### FIELD OF THE INVENTION

The present invention relates to a locator assembly for detecting, locating and also identifying objects. The present invention more specifically relates to a locator assembly having a sensor portion adapted to detect and locate a buried object and an identification portion adapted to identify and communicate with a buried object.

### BACKGROUND

Locators have been used to detect the location of buried objects. One example of a locator is a magnetic locator. Magnetic locators traditionally have been used to ascertain the location of buried magnetic, metallic and/or ferrous objects. For example, a magnetic locator may be used to ascertain the location of an intentionally buried object. Examples of an intentionally buried object may include, but are not limited to, underground piping, conduit, wires, valves and/or survey markers. Intentionally buried objects may include additional devices to facilitate locating the objects with a magnetic locator. For example, the objects may include a permanent magnet or magnetic marker which can be detected by a magnetic locator. Other objects may exhibit their own magnetic field which is detectable by a magnetic locator. For example, electrically charged buried wires may exhibit a magnetic field which can be detected by a magnetic locator.

However, magnetic locators have limitations. For example, while a magnetic locator may be able to detect the location of a wide variety of different buried objects, it is generally unable to identify the buried object(s). This may lead to false conclusions and/or error for users of a magnetic locator. For example, a surveyor may use a magnetic locator to detect the location of a survey monument. A survey monument generally is used as a geographic reference for later identification, and is frequently buried under ground or asphalt, or becomes buried and obscured from surface observation through erosion and/or plant growth. Survey monuments may be placed at the extremities of a parcel of land (e.g. corners) or along the boundaries of the land (e.g. property lines): Based upon the locations of the survey monuments, the surveyor can subsequently identify information about the physical location, for example the dimensions of the parcel of land. The location of the survey monument may be recorded, for example on a map or in a database. However, the exact location of many survey monuments may be either unknown or incorrectly recorded. Further, if the surveyor improperly identifies a survey monument, the information about the physical location marked by the survey monument may be incorrect.

Similarly, it can be difficult to identify one buried object from another with a magnetic locator. For example, metal conduits, unexploded ordinance, metal (e.g. rebar), and/or other metallic objects buried in the ground can present difficulty in trying to locate a survey monument with a magnetic locator. In addition, some locations are often surrounded with numerous, different sized buried ferrous objects. If any of these objects are buried near a survey monument, a magnetic reader may confuse the object(s) for a survey monument. This can lead a person to improperly pinpoint the location of a survey monument.

The misidentification of a buried object can result in legal issues, safety issues and/or other negative results. For example, a misidentified survey monument may negatively impact a property owner's lot size and/or property value. Further, a misidentified survey monument can result in a landowner relying upon an erroneous property boundary line. For example, a property owner may rely on a misidentified survey monument and construct a structure or other improvement upon land the property owner does not own. As another example, the misidentification of a buried object as a point of reference for determining safe or unsafe digging conditions may result in a hazardous or dangerous excavation project.

Often, the only way to identify a specific buried object is to dig and expose the identified object to determine if it is the specific object. However, it may be cost prohibitive, may not be desirable and/or may not be practical to excavate or to unearth a buried object solely for purposes of identification.

Accordingly, an improved locator assembly and method of detecting, locating and/or identifying one or more buried object(s) is provided.

### SUMMARY OF THE INVENTION

A locator assembly for the detection, location and identification of a buried object is provided comprising a sensor portion adapted to detect and measure the magnetic field strength of a buried object. A control assembly is connected to the sensor portion, wherein the control assembly is adapted to receive and analyze the magnetic field strength provided by the sensor portion to ascertain the location of a buried object. An identification portion is connected to the control assembly and operates independent of the sensor portion, wherein the identification portion is adapted to communicate with the buried object to ascertain the identity of the buried object.

A method of detecting, locating and identifying a buried object is also provided. The method includes detecting a magnetic field of a buried object about a portion of a ground surface with a sensor portion of a locator assembly, measuring the magnetic field strength of the magnetic field of the buried object with a locator assembly, locating the buried object below a portion of the surface of the ground, communicating with the buried object with an RFID interrogator, and sending and/or receiving information to and from an RFID tag attached to the buried object, including the identity of the buried object.

An additional method of detecting, locating and identifying a buried object is also provided. The method includes detecting information associated with a buried object about a portion of a ground surface with a sensor portion of a locator assembly, measuring the information associated with the buried object with a locator assembly, locating the buried object below a portion of the ground surface, interrogating the buried object with a first signal transmitted from an RFID interrogator, and receiving a second signal from an RFID tag attached to the buried object, wherein the second signal includes information including the identity of the buried object.

### BRIEF DESCRIPTION OF THE DRAWINGS

FIG. 1 is an elevation view of one or more examples of embodiments of a locator assembly having a sensor portion adapted to detect and locate a buried object.

FIG. 2 is a flow diagram of a method of detecting and locating a buried object using the locator assembly of FIG. 1.

FIG. 3 is a flow diagram of a method of ascertaining the depth of a buried object using the locator assembly of FIG. 1.

FIG. 4 is an elevation view of one or more examples of embodiments of a locator assembly of FIG. 1, showing a sensor portion adapted to detect and locate a buried object and an identification portion adapted to identify a buried object.

FIG. 5 is a flow diagram of a method of identifying and communicating with a buried object using the locator assembly of FIG. 4.

FIG. 6 is a flow diagram of a method of ascertaining the depth of a buried object using the locator assembly of FIG. 4.

FIG. 7 is an elevation view of one or more examples of embodiments of a locator assembly of FIG. 4, showing a sensor portion and an identification portion.

FIG. 8 is an elevation view of one or more examples of embodiments of a locator assembly of FIG. 4, showing a sensor portion and an identification portion.

FIG. 9 is an elevation view of one or more examples of embodiments of a locator assembly of FIG. 4, showing a sensor portion and an identification portion.

FIG. 10 is an elevation view of one or more examples of embodiments of a locator assembly of FIG. 4, showing a sensor portion and an identification portion.

FIG. 10A is a cut-away elevation view of the locator assembly of FIG. 10, taken from line 10A of FIG. 10, showing a cut-away of the fourth sensor assembly and its association to the connection assembly.

FIG. 11 is a flow diagram of a method of identifying and communicating with a buried object using the locator assembly of FIG. 10.

### DETAILED DESCRIPTION

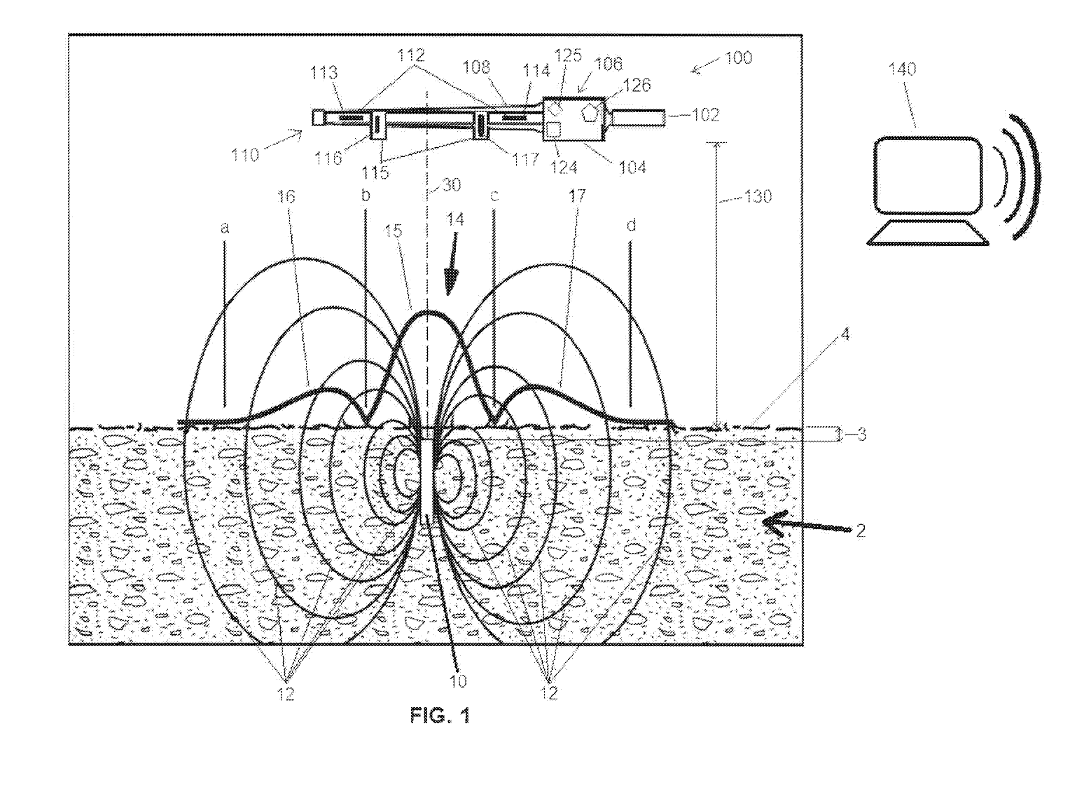

The invention shown in FIGS. 1-9 is generally directed to a locator assembly or reader 100, 200 having a sensor portion 110 adapted for the detection and location of a buried object and/or an identification portion 220 adapted for the identification of a buried object. For ease of discussion and understanding, the following detailed description and illustrations refer to a buried object 10 as a survey monument. It should be appreciated that a “survey monument” is provided for purposes of illustration and the locator assembly may be used to detect, locate and/or identify any type of buried object, for example, including but not limited to a magnetic object, a metallic object and/or a ferrous object. Further, it should be appreciated that the locator assembly 100, 200 may be used to detect, locate and/or identify any type of object, such as an intentionally buried object, for example, including but not limited to, underground piping, underground conduit, underground wires, underground valves, underground tanks, underground transformers and/or survey markers (e.g. a survey monument).

FIG. 1 is an elevation view of an example of an embodiment of a locator assembly 100 having a sensor portion 110 adapted to detect and locate a buried object 10 and an associated method to ascertain the depth of a buried object 10. Referring to FIG. 1, a buried object 10 may be buried in material or ground 2. The buried object 10 may be provided a distance or depth 3 below the surface of the ground 4 or into the ground 2. In one or more examples of embodiments, the buried object 10 may be provided in any position, at any angle to and/or in any orientation to the surface of the ground 4. In one or more examples of embodiments, the buried object 10 may be buried in the ground 2 any distance 3 from the surface of the ground 4. Further, in one or more examples of embodiments, a portion of the buried object 10 may be provided above the surface of the ground 4 (e.g. away from the ground 2), may be visible from the surface of the ground 4 and/or may extend a distance away from the ground 2 and through the surface of the ground 4. In one or more examples of embodiments, the ground 2 may be any material or combination of material, including, but not limited to, soil, sand, rock, mineral, asphalt and/or debris (e.g. a collapsed structure or building). In one or more examples of embodiments, the buried object 10 may include one or more embodiments of a survey marker as disclosed in United States Published Patent Application No. 2010/0295699 to Rushing.

As shown in FIG. 1, the buried object 10 may be a magnetic, metallic and/or ferrous object which may exhibit or emit a magnetic field 12. The magnetic field 12 is represented in FIG. 1 by arcuate or curvilinear lines illustrating the magnetic field lines emanating from buried object 10. The buried object 10 may also include a magnetic field strength 14 at the surface of the ground 4. The strength of the magnetic field 14 is illustrated as a tri-modal curve, or a curve having three peaks. The first peak 15 is shown as the strongest or tallest peak of the strength of the magnetic field 14, as it includes portions of the entire magnetic field 12 (illustrated as the portion of magnetic field 12 between vertical reference lines b and c). The second peak 16 and third peak 17 are shown as weaker or smaller peaks of the strength of the magnetic field 14, as they respectfully include only a portion of the magnetic field 14 (respectively illustrated as the portion of magnetic field 12 between vertical reference lines a and b, and between vertical reference lines c and d). The strength of the magnetic field 14 at the surface of the ground 4 correlates to the intensity of the magnetic field 12 emitted by the buried object 10. Further, for example, the strength of the magnetic field 14 at the surface of the ground 4 is proportional to the distance 3 the buried object 10 is provided from the surface of the ground 4 (e.g. the magnetic field strength 14 may decrease at the surface of the ground 4 the deeper or greater distance into the ground 2 and away from the surface of the ground 4 the buried object 10 is provided). In one or more examples of embodiments, the buried object 10 may be any shape, size, and/or material which may exhibit a magnetic field 12. In one or more examples of embodiments, the buried object 10 may be a non-metallic and/or non-ferrous object, however may include a magnet and/or a portion which emits a magnetic field 12. Further, in one or more examples of embodiments, the magnetic field 12 and/or strength of magnetic field 14 may be rotated, provided in any position, at any angle to and/or in any orientation to the surface of the ground 4 based upon the positioning of the buried object 10 and/or positioning of the source of the magnetic field 12 in association with the surface of the ground 4.

As illustrated in FIG. 1, a locator assembly or reader or underground detection and location device 100 is provided. The locator assembly 100 may include a handle 102 connected to or in communication with a control assembly 104. The control assembly 104 may house a sensor controller or magnetic locator 106. An output device 124 may be housed in the control assembly and connected to or in communication with the sensor controller 106 such that the output device 124 may provide information to a user based upon the operation of the sensor controller 106. A wand assembly or wand 108 may be connected to or in communication with the control assembly 104. Wand 108 may house a sensor portion or magnetic sensor portion 110. In one or more examples of embodiments, the output device 124 may include a speaker system for providing an audible tone, a display (e.g. an LED display), or any other known or future developed device for providing information (e.g. the measured strength and/or polarity (e.g. plus or minus) of magnetic field 14). In one or more examples of embodiments, the sensor portion 110 may be in communication with or connected to wand 108, for example, but not limited to, connected to the outer surface of wand 108.

As shown in FIG. 1, the sensor portion 110 may include a first sensor assembly 112 and a second sensor assembly 115. The first sensor assembly 112 may include a first sensor 113 and a second sensor 114. The second sensor assembly 115 may include a third sensor 116 and a fourth sensor 117. As illustrated in FIG. 1, the first and second sensors 113, 114 are provided a distance apart in a first arrangement. The third and fourth sensors 116, 117 are provided a distance apart and in a second arrangement, such that the third and fourth sensors 116, 117 are provided perpendicular or approximately perpendicular to the first and second sensors 113, 114. In one or more examples of embodiments, the first sensor assembly 112 may include two or more sensors adapted to detect a buried object 10. Further, in one or more examples of embodiments, the second sensor assembly 115 may include two or more sensors adapted to detect a buried object 10. In one or more examples of embodiments, the first and second sensors 113, 114 may be provided in any arrangement (e.g. angle) or distance apart from one another in order to effectively detect a buried object 10 in accordance with the description provided herein. Further, in one or more examples of embodiments, the third and fourth sensors 116, 117 may be provided in any arrangement (e.g. angle) or distance apart from one another in order to effectively detect a buried object 10 in accordance with the description provided herein. In one or more examples of embodiments, the third and fourth sensors 116, 117 may be provided in any arrangement, at any distance from the first and second sensors 113, 114 and/or at any angle to the first and second sensors 113, 114 suitable for operation of the locator assembly 100 and detection of a buried object 10 in accordance with the description provided herein. In one or more examples of embodiments, the first sensor assembly 112 and second sensor assembly 115 may include any number, arrangement and/or type of sensor(s) adapted to detect a magnetic field 12 and/or measure the magnetic field strength 14 of a magnetic field 12.

The sensor portion 110 may be in communication with the control assembly 104, and specifically may be in communication with the sensor controller or magnetic locator 106. Referring to FIG. 1, the first sensor assembly 112 and second sensor assembly 115 may be in communication with the sensor controller or magnetic locator 106. The sensor controller 106 may include a switch or selector or controller or actuator 125 adapted to activate or deactivate the second sensor assembly 115 independent of the first sensor assembly 112. For example, the sensor controller 106 may include a switch 125 adapted to activate the first sensor assembly 112 and deactivate the second sensor assembly 115 in a first position, and to activate the second sensor assembly 115 and deactivate the first sensor assembly 112 in a second position. In one or more examples of embodiments, the first sensor assembly 112 may be in communication with the sensor controller 106, while the second sensor assembly 115 may be in communication with a second, separate controller 126 housed within or connected to control assembly 104, wherein the controllers are adapted to provide independent operation and control of the respective first and second sensor assemblies 112, 115.

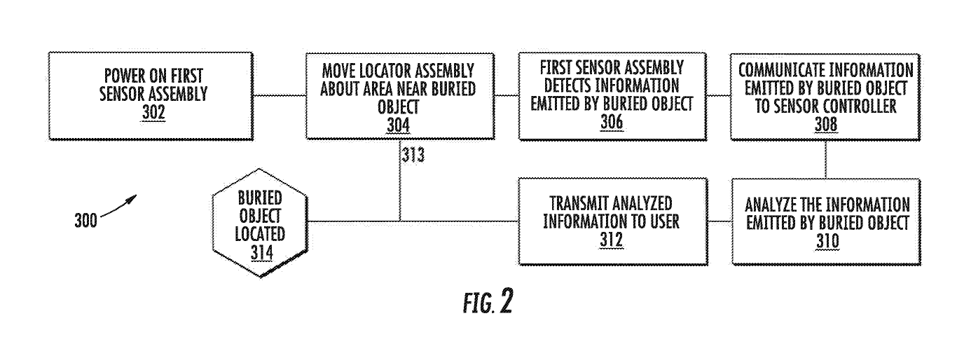

In operation and use, a user may use the locator assembly 100 to detect the magnetic field 12 of a buried object 10, enabling the user to ascertain the location of or locate the buried object 10. Further, the user may use the locator assembly 100 to ascertain the depth or distance 3 a buried object 10 is buried into ground 2. FIG. 2 illustrates a method 300 of using the locator assembly 100 to detect and locate a buried object 10, which is depicted in flow chart or flow diagram form. At step 302, the user may grasp the magnetic locator 100, for example utilizing handle 102, and activate or trigger or switch on or power on the first sensor assembly 112. At step 304, the user may move the wand 108 in an area near the buried object 10. The first sensor assembly 112 may detect information emitted by the buried object 10, for example information associated with the strength of the magnetic field 14, at step 306. At step 308, the information emitted by the buried object gathered by the first sensor assembly 112, and associated first and second sensors 113, 114, is communicated to the sensor controller 106. For example, the strength of the magnetic field 14 information gathered by the first sensor assembly 112 is communicated to the sensor controller 106. At step 310, the sensor controller 106 may analyze the information emitted by the buried object and gathered by the first sensor assembly 112. For example, the strength of the magnetic field 14 information may be analyzed by the sensor controller 106. The analysis may include, but is not limited to, determining the difference between the strength detected by the first and second sensors 113, 114 of the first sensor assembly 112. The comparative analysis allows the sensor controller 106 to filter out background magnetic fields, for example, but not limited to, the magnetic field of the Earth, which will be approximately constant at the respective position of the first and second sensors 113, 114 of the first sensor assembly 112. In addition, the strength of the magnetic field 14 of the buried object 10 will vary between the first and second sensors 113, 114 of the first sensor assembly 112, as the magnetic field 12 is closer to the first sensor assembly 112 and stronger than any background magnetic fields. At step 312, the sensor controller 106 may then transmit the resulting information to the user, for example through the output device 124. In one or more examples of embodiments, the sensor controller 106 may transmit or communicate the resulting information to a programmable computer system 140 (see FIG. 1).

If the user requires additional strength of magnetic field 14 information to ascertain the location of a buried object 10, the user may move the locator assembly 100 in another area near the buried object 10 at step 313. As the user moves the wand 108 of the locator assembly 100, the information acquired by the first sensor assembly 112 and/or transmitted by the sensor controller 106 may change. By repeating steps 304 through 313, a user may utilize this changing information provided by the sensor controller 106 to locate the approximate position of a buried object 10, for example, but not limited to, utilizing controlled patterns, until the locator assembly 100 is positioned at the surface of the ground 4 directly above the buried object 10. The user may repeat steps 304 through 313 until the location of the buried object 10 has been ascertained at step 314. Typically, the wand 108 may be vertically positioned above the buried object 10 with the first and second sensors 113, 114 vertically aligned above the detected buried object 10 to very closely indicate the position of the buried object 10.

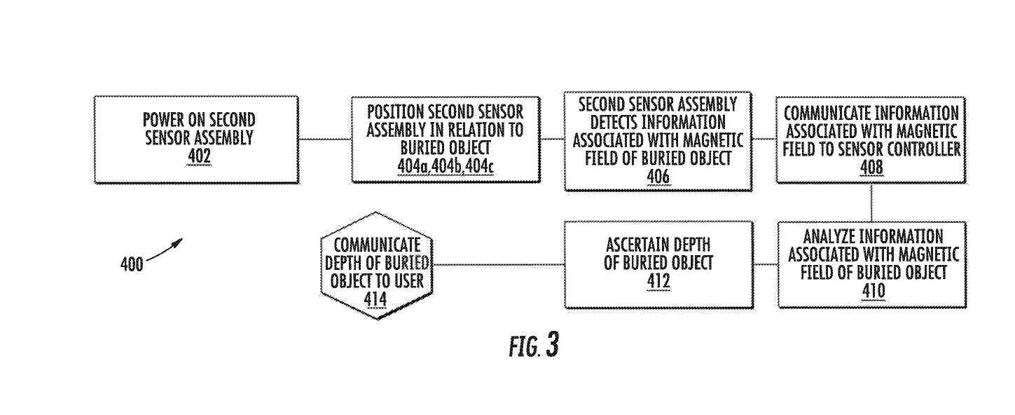

Once the transverse position of the buried object 10 has been detected and located, a user may utilize the second sensor assembly 115 to ascertain the depth or distance 3 a buried object 10 is buried into ground 2. FIG. 3 illustrates a method 400 of using the locator assembly 100 to ascertain the depth or distance 3 a buried object 10 is buried into ground 2, which is depicted in flow chart or flow diagram form. At step 402, the user may activate or trigger or switch on or power on the second sensor assembly 115. In one or more examples of embodiments, in conjunction with the activation of the second sensor assembly 115, the user may deactivate the first sensor assembly 112 or the first sensor assembly 112 may automatically deactivate.

At step 404a, the user may position or reposition the locator assembly 100 such that the second sensor assembly 115 can ascertain the depth 3 of the buried object 10. For example, in the example of embodiment of the locator assembly 100 illustrated in FIG. 1, the wand 108 is positioned parallel to the surface of the ground 4 (e.g. horizontally) to allow the third and fourth sensors 117, 118 of the second sensor assembly 115 to operate and ascertain the depth of the buried object 10. In one or more examples of embodiments, the locator assembly 100 may be positioned or provided in any arrangement, direction, or angle to the surface of the ground 4 which allows for operation of the second sensor assembly 115.

At step 404b, the second sensor assembly 115 may be positioned or provided at a known distance between the sensors of the second sensor assembly 115. For example, in the example of the embodiment of the locator assembly 100 illustrated in FIG. 1, the wand 108 is positioned such that an imaginary line 30 from the buried object 10 would intersect the wand 108 of the locator assembly 100 at a known distance between the third and fourth sensors 117, 118. To this end, the wand 108 may include an alignment aid (not shown) provided at a known distance between the third and fourth sensors 117, 118. For example, the alignment aid (not shown) may be a marker line provided on the wand housing. The alignment aid (not shown) may assist a user to align the locator assembly 100 with a location on the surface of the ground 4 directly above the buried object 10. In one or more examples of embodiments, the wand 108 may be provided in relation to the imaginary line 30 such that the imaginary line 30 intersects wand 108 equidistant between or equally between the third and fourth sensors 117, 118.

At step 404c, the locator assembly 100 may be provided at a position from the surface of the ground 4. For example, in the example of the embodiment of the locator assembly 100 illustrated in FIG. 1, the wand 108 is positioned at a distance 130 from the surface of the ground 4. The distance 130 is preferably known. In one or more examples of embodiments, the locator assembly 100 may be provided at any distance or known distance 130 from the surface of the ground. Further, in one or more examples of embodiments, the locator assembly 100 may be used with an attachment of a distance or known distance from the surface of the ground, for example, but not limited to, a stand. In one or more examples of embodiments, the locator assembly 100 may have a minimal to no distance 130 from the surface of the ground 4, for example, but not limited to, placing or the locator assembly 100 on to the surface of the ground 4.

Once the locator assembly 100 is provided in the necessary position(s), a user may employ the second sensor assembly 115 to ascertain the depth 3 a buried object 10 is buried into ground 2. For example, in the example of the embodiment of the locator assembly 100 illustrated in FIG. 1, the second sensor assembly 115 may gather information associated with the magnetic field 12, for example, the strength of the magnetic field 14, at step 406. At step 408, the information may be communicated to the sensor controller 106 for analysis. At step 410, the sensor controller 106 may analyze the information with other information known from the buried object, for example, but not limited to, the known strength of the magnetic field at the source of the buried object (e.g. the known magnetic field strength of an intentionally buried object 10) and/or the known strength of the magnetic field of the buried object 10 at the surface of the ground 4 or a known distance 130 from the surface of the ground 4 (e.g. the known magnetic field strength measured and recorded after the intentionally buried object 10 was buried). An example of the analysis of the information, may include, but is not limited to, a comparison of the measured strength of the magnetic field 14 of the buried object 10 with a known value of the strength of the magnetic field 14 of the buried object 10. As an additional example of an analysis of the information, the information can be used to calculate and/or triangulate the depth 3 of the buried object 10 from the surface of the ground 4, for example, but not limited to, Gauss magnetic field strength equations. As step 412, the depth 3. of the buried object 10 may be ascertained. The results of the depth 3 of the buried object 10 may be subsequently communicated to the user through the output device 124.

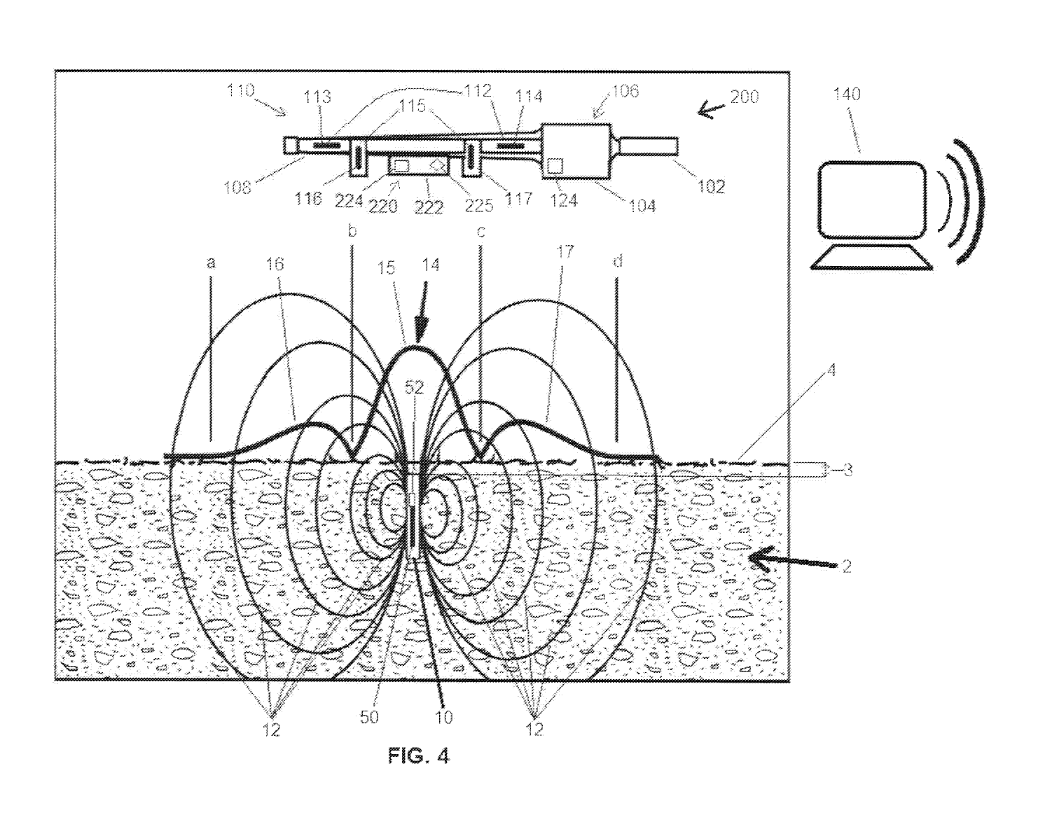

FIG. 4 illustrates an improved locator assembly for detecting, locating and identifying a buried object 10. Referring to FIG. 4, a locator assembly or reader or underground detection, location and identification device 200 is provided. The locator assembly 200 includes features which are substantially as described herein in association with the locator assembly 100. Operation and particular components described herein are substantially the same and like numbers have been used to illustrate the like components.

As illustrated in FIG. 4, the locator assembly 200 includes an identification portion 220 attached to or in communication with wand 108. The identification portion 220 includes a third sensor assembly 222, illustrated as a radio-frequency identification (RFID) reader or interrogator 222. The RFID reader 222 may include an antenna 224 for receiving and transmitting a radio-frequency signal. In one or more examples of embodiments, the third sensor assembly 222 may include any known or future developed sensor or communication device adapted to wirelessly communicate with a buried object 10. The RFID reader 222 may be provided on the surface of wand 108, for example, but not limited to, between the third and fourth sensors 116, 117 of the second sensor assembly (as shown in FIG. 4). In one or more examples of embodiments, the RFID reader 222 may be provided in an alternate location of the locator assembly 200, for example, but not limited to, within or enclosed by the wand, connected to an alternate surface of the wand, connected to a portion of the locator assembly 200, or incorporated into the control assembly 104. Further, in one or more examples of embodiments, the identification portion 220 may operate independently of the first sensor assembly 112 and/or second sensor assembly 115, for example, the identification portion 220 may operate or be powered on while the first sensor assembly 112 and/or second sensor assembly 115 is not operating or powered down or off.

As shown in FIG. 4, the buried object 10 may include a communication device or tag or label 50 adapted to communicate with the third sensor assembly 222 of the identification portion 220. For example, in the example of the embodiment of the buried object 10 shown in FIG. 4, the buried object 10 includes a communication device 50, illustrated as an RFID tag or label 50. In one or more examples of embodiments, the RFID tag or label 50 may include an integrated circuit or memory 52 adapted to store and/or process information and/or modulate and/or demodulate a radio-frequency (RF) signal. Further the RFID tag or label 50 may include an antenna for receiving and transmitting an RF signal. In one or more examples of embodiments, the RFID tag or label 50 may be a passive RFID tag (e.g. a tag which has no power source and may require an external electromagnetic field to initiate a signal transmission), an active RFID tag (e.g. a tag which contains a battery, photovoltaic cell, or other power source and can transmit signals following identification of an external source or reader or interrogator), or a battery assisted passive RFID tag (e.g. a tag which requires an external power source to power on or “wake up,” but which has a higher forward link capability to provide a greater range of operation than an active or passive RFID tag). In one or more examples of embodiments, the communication device 50 may include any known or future developed device adapted to store information, receive information, send information, and/or communicate information with the third sensor assembly 222. In one or more examples of embodiments, the buried object 10 having a communication device 50 may include one or more embodiments of a survey marker as disclosed in United States Published Patent Application No. 2010/0295699 to Rushing.

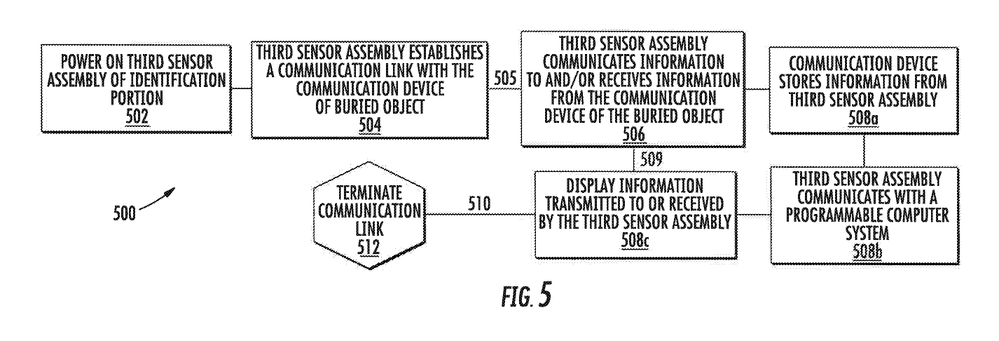

In operation and use of the locator assembly 200, a user may proceed with the steps as substantially described herein in association with the locator assembly 100 and illustrated in FIG. 2 to detect and locate a buried object. In addition, the user may use the locator assembly 200 to identify and/or communicate with a buried object 10. FIG. 5 illustrates a method 500 of using the identification portion 220 to identify and communicate with a buried object 10, which is depicted in flow chart or flow diagram form.

Referring to FIG. 5, the third sensor assembly 222 may be activated or operated to communicate (e.g. send and/or receive information) with the communication device 50 of the buried object 10. At step 502, the user may activate or trigger or switch on or power on the identification portion 220 and associated third sensor assembly or RFID interrogator 222. In one or more examples of embodiments, in conjunction with the activation of the third sensor assembly 222, the user may deactivate or switch off the first sensor assembly 112 and/or second sensor assembly 115. For example, the first sensor assembly 112 and/or second sensor assembly 115 may he interlocked to switch off upon activation of the third sensor assembly 222.

At step 504, the third sensor assembly 222 may establish a communication link or information exchange link with the communication device 50 of buried object 10. At step 505, the third sensor assembly 222 may identify the communication device 50 of buried object 10. For example, the third sensor assembly 222 may send to and/or receive a signal from the communication device 50 having identification information. If the buried object 10 is identified as the intended or targeted buried object, a user of the third sensor assembly 222 may wish to send, receive or communicate additional information with the communication device 50 of buried object 10.

At step 506, the third sensor assembly 222 may communicate with the communication device 50. For example, as shown in the illustrated embodiments of FIG. 4, the third sensor assembly 222 of the identification portion 220 may be an RFID reader or interrogator 222. The MD interrogator 222 may send a radio frequency (RF) signal to the buried object 10. The communication device 50, which may be an RFID tag 50, may receive the RF signal and in response, may transmit an RF signal back to the RFID interrogator 222. The RF signal from the RFID tag 50 to the RFID interrogator 222 may include information stored on the RFID tag 50. The information may include an identification number that identifies the specific RFID tag 50, and thus the specific buried object 10 associated with that RFID tag (e.g., a permanently locked alphanumeric number of a standard length), identifying information (e.g. location information, a serial number and/or a type code), a geographic position of the RFID tag 50 and/or the buried object 10 (e.g., GPS coordinates, latitude and longitude readings, and/or Public Land Survey System (PLSS) coordinates), information about the date the buried object 10 was placed, buried and/or updated, who placed the object, who last updated the information associated with the buried object 10, distances to other markers or points of interest (e.g., distance along a buried pipe until a split is reached), legal information (e.g. easement information or property boundaries in association with the property surrounding the buried object 10), and/or any other desired information. In one or more examples of embodiments, the information stored on the communication device or RFID tag 50 may be electronically locked or protected by password, for example to reduce or prevent counterfeiting, tampering, or alteration of information associated with the communication device or RFID tag 50. In one or more examples of embodiments, third sensor assembly 222 may exchange information with or acquire information from or transmit information to the communication device 50.

At step 508a, the communication device 50 may store information communicated from or transmitted by the third sensor assembly 222. For example, the RFID tag 50 may be able to receive information from the RFID interrogator 222 and encode or save that information into a memory of the RFID tag 50.

At step 508b, the third sensor assembly 222 may transmit information to, receive information from, and/or be in communication with a programmable computer system 140 through a communication link (not shown) (see FIG. 4). For example, the third sensor assembly 222 may communicate with the programmable computer system 140 by wireless communication, such as, but not limited to, a cellular network (e.g. a mobile phone device) or a wireless internet connection, or by wired communication, such as, but not limited to, a Category 5 or Cat5 cable. In one or more examples of embodiments, the programmable computer system 140 may include a database or a machine-readable medium including instructions, which, when executed, cause the computer system 140 to perform operations. For example, the database may include information relating to the buried object 10, including, but not limited to, information regarding land rights (e.g. legal ownership or legal boundaries), GPS coordinates of the buried object 10, and/or known buried objects in the area around buried object 10. It should be appreciated that in one or more examples of embodiments, step 508b may be performed in conjunction with step 508a, or in the place of step 508a.

At step 508c, information transmitted to or received by the third sensor assembly 222 may be displayed to the user. In one or more examples of embodiments, a screen or display 225 (e.g. an LED display) may be in communication with the third sensor assembly 222 to display information received by the third sensor assembly 222, for example, but not limited to, received from the communication device 50, computer system 140, or database associated with the computer system 140. In one or more examples of embodiments, the third sensor assembly 222 may be in communication with the output device 124 to display information associated with the third sensor assembly 222. Further, in one or more examples of embodiments, the information may be displayed to the user on a wireless device, for example, but not limited to a mobile phone device or computer system 140. It should be appreciated that in one or more examples of embodiments, step 508c may be performed in conjunction with steps 508a and/or 508b, or in the place of steps 508a and/or 508b.

At step 509, the user may subsequently transmit additional information to, receive additional information from, and/or be in additional communication with the communication device 50. To this end, the user may repeat one or more of steps 506 through 508.

At step 510, the user may complete any and all communication with the communication device 50 of the buried object 10. To this end, at step 512, the user may terminate or break the communication link between the third sensor assembly 222 and communication device 50.

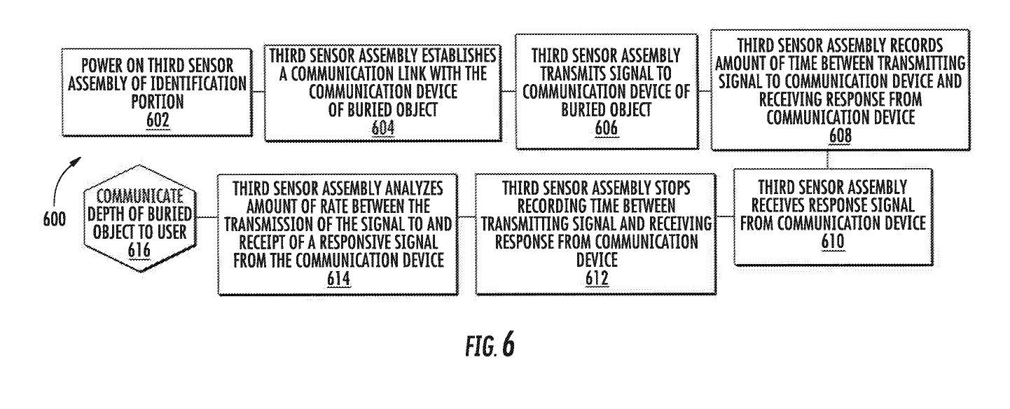

In addition, the third sensor assembly or RFID interrogator 222 may he used to ascertain the depth 3 of a buried object 10. Further, the third sensor assembly or RFID interrogator 222 may be used to confirm the depth 3 determination of the buried object 10 as substantially described herein in association with the locator assembly 100 and illustrated in FIG. 3. FIG. 6 illustrates a method 600 of using the identification portion 220 to ascertain the depth of a buried object 10, which is depicted in flow chart or flow diagram form.

Referring to FIG. 6, the third sensor assembly 222 may be activated or operated to communicate (e.g. send and/or receive information) with the communication device 50 of the buried object 10. At step 602, the user may activate or trigger or switch on or power on the identification portion 220 and associated third sensor assembly or RFID interrogator 222. In one or more examples of embodiments, in conjunction with the activation of the third sensor assembly 222, the user may deactivate or switch off the first sensor assembly 112 and/or second sensor assembly 115. For example, the first sensor assembly 112 and/or second sensor assembly 115 may he interlocked to switch off upon activation of the third sensor assembly 222. In one or more examples of embodiments, the third sensor assembly 222 may already be powered on, for example, during the identification of or communication with a buried object 10 as illustrated in FIG. 5.

At step 604, the third sensor assembly 222 may establish a communication link or information exchange link with the communication device 50 of buried object 10. In one or more examples of embodiments, the third sensor assembly 222 may already have a communication link with the communication device 50 of buried object 10, for example, during the identification of or communication with a buried object 10 as illustrated in FIG. 5.

At step 606, the third sensor assembly 222 may transmit or send a signal to the communication device 50 on the buried object 10. In conjunction with transmission of the signal to the communication device 50, at step 608 the third sensor assembly 222 may record the amount of time or rate before a response is received from the communication device 50. At step 610, the third sensor assembly 222 may receive a responsive signal from the communication device 50 on the buried object 10. At step 612, the third sensor assembly 222 stops recording the amount time or rate before receiving a response from the communication device 50. At step 614, the third sensor assembly 222 analyzes the amount of time or rate between the transmission of the signal to and receipt of a responsive signal from the communication device 50. Based upon the analysis of the rate at which the signal will travel through the ground 2, the distance or depth 3 to the buried object 10 can he determined. At step 616, the distance or depth 3 of the buried object 10 is communicated to the user. For example, the depth 3 of the buried object 10 may be communicated to the user through an output device 124 or display 225 in communication with the third sensor assembly 222.

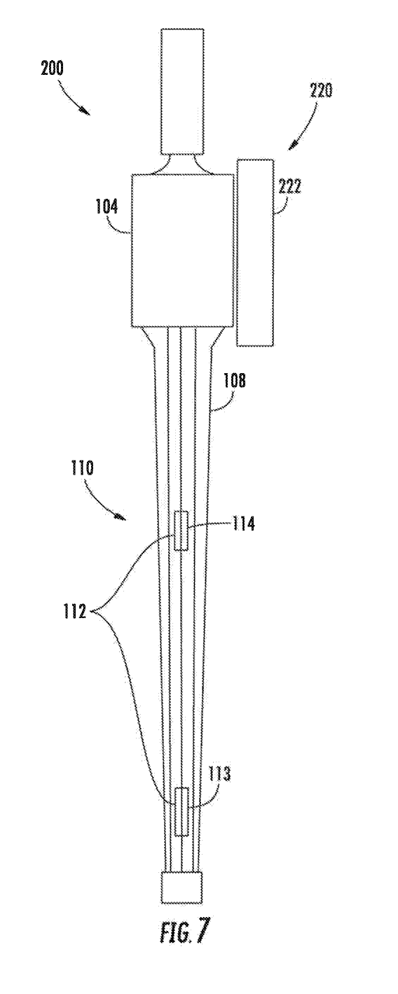

FIGS. 7-9 illustrate one or more alternative examples of embodiments of the locator assembly 200. The locator assembly 200 shown in FIGS. 7-9 includes features which are substantially as described herein in association with the locator assembly 200. Operation and particular components described herein are substantially the same and like numbers have been used to illustrate the like components.

Referring to FIG. 7, in this embodiment, the locator assembly 200 may include a sensor portion 110 having a first sensor assembly 112. The first sensor assembly 112 may include a first sensor 113 and a second sensor 114. The first sensor assembly 112 may be a magnetic sensor adapted to detect and measure information associated with the magnetic field 12, for example the strength of a magnetic field 14, of a buried object 10.

In addition, the locator assembly 200 may include an identification portion 220. The identification portion may include a third sensor assembly 222. The third sensor assembly 222 may he an RFID reader or interrogator 222 adapted to communicate with a communication device 50 associated with or connected to a buried object 10, for example, but not limited to, an RFID tag 50. As illustrated in FIG. 7, the locator assembly 200 is in communication with or connected to a portion of the control assembly 104. In one or more examples of embodiments, the identification portion 220 may operate independently of the sensor portion 110, for example, the identification portion 220 may operate or be powered on while the sensor portion 110 is not operating or powered down or off

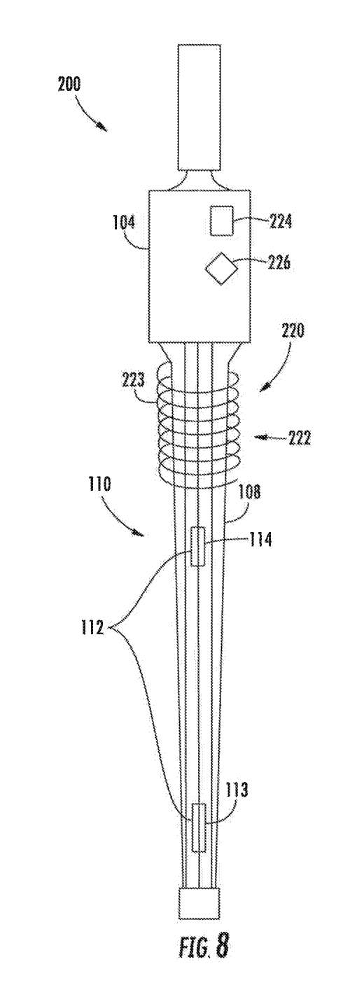

Referring to FIG. 8, in this embodiment, the locator assembly 200 includes a sensor portion 110 having a first sensor assembly 112. The first sensor assembly 112 may include a first sensor 113 and a second sensor 114. The first sensor assembly 112 may be a magnetic sensor adapted to detect and measure information associated with the magnetic field 12, for example the strength of a magnetic field 14, of a buried object 10. In addition, the locator assembly 200 may include an identification portion 220. The identification portion may include a third sensor assembly 222. The third sensor assembly 222 may be an RFID reader or interrogator 222 adapted to communicate with a communication device 50 associated or connected to a buried object 10, for example, but not limited to, an RFID tag 50.

As illustrated in FIG. 8, the third sensor assembly 222 includes a helical or coiling antenna 223 adapted to wrap around a portion of the wand assembly 108. The helical antenna 223 is schematically shown as making approximately six wraps or turns about the wand assembly 108. In one or more examples of embodiments, the helical antenna 223 may include fewer than six wraps, greater than six wraps or any number of wraps in order to provide an effective signal to communicate with a communication device 50 associated with or connected to a buried object 10. In addition, the helical antenna 223 is illustrated as extending about or along a portion of the wand assembly 108. For example, the illustrated helical antenna 223 may extend along the wand assembly 108 between a distance of 2.50 inches to 22.50 inches, and more preferably approximately 5.25 inches. The above described distances are listed for exemplary purposes only and are not intended to be limiting. In addition, the helical antenna 223 may extend along the wand assembly 108, but does not overlap the first or second sensors 113, 114 (as shown in FIG. 8). In one or more examples of embodiments, the helical antenna 223 may be covered or surrounded by a protective cover, shroud, or other known or future developed covering adapted to protect the helical antenna 223 while not limiting operation of the helical antenna 223. In one or more examples of embodiments, the identification portion 220 may operate independently of the sensor portion 110, for example, the identification portion 220 may operate or be powered on while the sensor portion 110 is not operating or powered down or off. In one or more examples of embodiments, the control assembly 104 may include a third sensor assembly controller 224 which may be connected to or in communication with the helical antenna 223. The third sensor assembly controller 224 may include a reader 226 adapted to communicate and receive information through the use of the helical antenna 223.

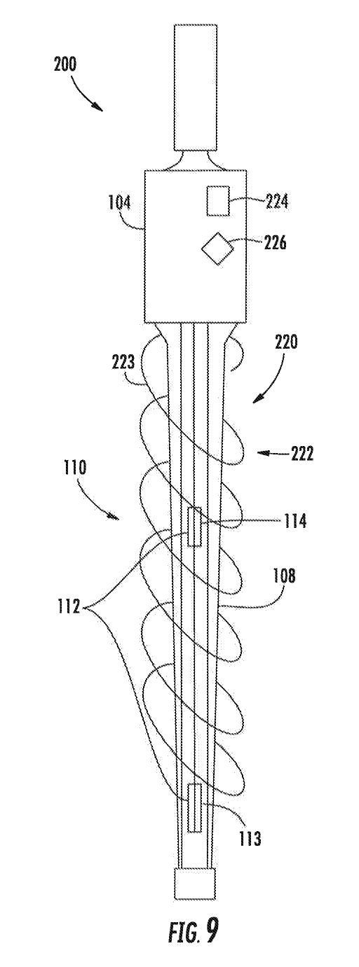

Referring to FIG. 9, in this embodiment, the locator assembly 200 includes a sensor portion 110 having a first sensor assembly 112. The first sensor assembly 112 may include a first sensor 113 and a second sensor 114. The first sensor assembly 112 may be a magnetic sensor adapted to detect and measure information associated with the magnetic field 12, for example the strength of a magnetic field 14, of a buried object 10. In addition, the locator assembly 200 may include an identification portion 220. The identification portion may include a third sensor assembly 222. The third sensor assembly 222 may be an RFID reader or interrogator 222 adapted to communicate with a communication device 50 associated or connected to a buried object 10, for example, but not limited to, an RFID tag 50.

As illustrated in FIG. 9, the third sensor assembly 222 includes a helical or coiling antenna 223 adapted to wrap around a portion of the wand assembly 108. The helical antenna 223 is shown as making approximately six wraps or turns about the wand assembly 108. In one or more examples of embodiments, the helical antenna 223 may include fewer than six wraps, greater than six wraps or any number of wraps in order to provide an effective signal to communicate with a communication device 50 associated with or connected to a buried object 10. In addition, the helical antenna 223 is illustrated as extending about or along a portion of the wand assembly 108. For example, the illustrated helical antenna 223 may extend along the wand assembly 108 between a distance of 2.50 inches to 22.50 inches, and more preferably approximately 18.50 inches. The above described distances are listed for exemplary purposes only and are not intended to be limiting. In addition, the helical antenna 223 may extend along the wand assembly 108 and overlap a portion of the first sensor assembly 112, for example the second sensor 114 (as shown in FIG. 9). In one or more examples of embodiments, the helical antenna 223 may extend along the wand assembly 108 and overlap a portion of the first sensor assembly 112, including the first and second sensors 113, 114. In one or more examples of embodiments, the helical antenna 223 may be covered or surrounded by a protective cover, shroud, or other known or future developed covering adapted to protect the helical antenna 223 while not limiting operation of the helical antenna 223. In one or more examples of embodiments, the identification portion 220 may operate independently of the sensor portion 110, for example, the identification portion 220 may operate or be powered on while the sensor portion 110 is not operating or powered down or off In one or more examples of embodiments, the control assembly 104 may include a third sensor assembly controller 224 which may be connected to or in communication with the helical antenna 223. The third sensor assembly controller 224 may include a reader 226 adapted to communicate and receive information through the use of the helical antenna 223.

In operation and use of the one or more examples of embodiments of the locator assembly 200 illustrated in FIGS. 7-9, a user may use the locator assembly 200 to detect information associated with the magnetic field 12 of a buried object 10, enabling the user to ascertain the location of and/or locate the buried object 10. To this end, the user may proceed with the steps as substantially described herein in association with the locator assembly 100 and illustrated in FIG. 2 to detect and locate a buried object.

In addition, the user may use the locator assembly 200 illustrated in FIGS. 7-9 to identify and/or communicate with the buried object 10. To this end, the user may proceed with the steps as substantially described herein in association with the locator assembly 200 and illustrated in FIG. 5 to identify and/or communicate with the buried object 10.

In addition, the user may use the locator assembly 200 illustrated in FIGS. 7-9 to determine the depth of the buried object 10. To this end, the user may proceed with the steps as substantially described herein in association with the locator assembly 200 and illustrated in FIG. 6 to ascertain or determine the depth 3 of the buried object 10.

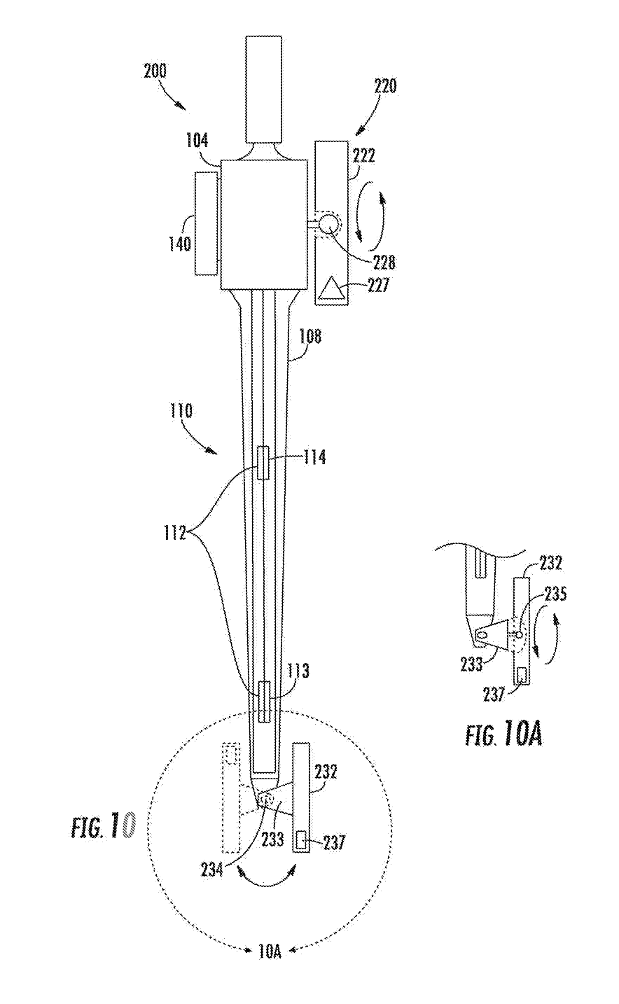

FIG. 10 illustrates one or more alternative examples of embodiments of the locator assembly 200. The locator assembly 200 shown in FIG. 10 includes features which are substantially as described herein in association with the locator assembly 200. Operation and particular components described herein are substantially the same and like numbers have been used to illustrate the like components.

Referring to FIG. 10, the locator assembly 200 may include a sensor portion 110 having a first sensor assembly 112. The first sensor assembly 112 may include a first sensor 113 and a second sensor 114. The first sensor assembly 112 may be a magnetic sensor adapted to detect and measure information associated with the magnetic field 12, for example the strength of a magnetic field 14, of a buried object 10.

The locator assembly 200 may include an identification portion 220. The identification portion 220 may include a third sensor assembly 222 and a fourth sensor assembly 232. As illustrated in FIG. 10, the third sensor assembly 222 may include an antenna 227. The third sensor assembly 222 may be a first RFID reader or first interrogator 222 adapted to communicate with a communication device 50 associated with or connected to a buried object 10, for example, but not limited to, an RFID tag 50. The first RFID interrogator 222 may be connected to or in communication with a portion of the control assembly 104. As shown in FIG. 10, a portion of the first RFID interrogator 222 is cut-away to illustrate a bearing or spherical member 228 connected to the control assembly 104. The spherical member 228 is received by a portion of the first RFID interrogator 222. This allows the first RFID interrogator 222 to rotate about the spherical member 228.

The fourth sensor assembly 232 may include an antenna 237. The fourth sensor assembly 232 may be a second RFID reader or second interrogator 232 adapted to communicate with a communication device 50 associated with or connected to a buried object 10, for example, but not limited to, an RFID tag 50. The second RFID interrogator 232 may be connected to or in communication with a portion of the wand 108. As shown in FIG. 10, the second RFID interrogator 232 may be connected to a connection assembly 233. The connection assembly 233 may be pivotally connected to a tip 109 of the wand 108. The connection assembly 233 receives a pivot member 234 which engages or connects to the tip 109 of wand 108. This allows the connection assembly 233 and associated second RFID interrogator 232 to pivot or swivel about the pivot member 234, as illustrated in FIG. 10 by broken lines. In one or more examples of embodiments, the fourth sensor assembly 232 may include a plurality of RFID readers or interrogators.

In one or more examples of embodiments, the first RFID interrogator 222 may operate concurrently with the second RFID interrogator 232, for example, to detect and differentiate two or more RFID tags 50 which may be provided in close proximity to one another or close together. In one or more examples of embodiments, the first RFID interrogator 222 may operate at the same frequency as the second RFID interrogator 232. Further, in one or more examples of embodiments, the first RFID interrogator 222 may operate at a different frequency than the second RFID interrogator 232. For example, the first RFID interrogator 222 may operate at one of, but not limited to, a low frequency (LF), high frequency (HF), very high frequency (VHF), ultra high frequency (UHF), up to and including microwave. The second RFID interrogator 232 may operate at one of, but not limited to, one of the disclosed frequencies which is different than the frequency of the first RFID interrogator 222. In one of more examples of embodiments the first RFID interrogator 222 may operate at a different modulation than the second RFID interrogator 232. For example, the first RFID interrogator 222 may operate at a frequency modulation (FM), while the second RFID interrogator 232 may operate at an amplitude modulation (AM). In one or more examples of embodiments, the antennas 227, 237 may be circularly and/or linearly polarized. Further, in one or more examples of embodiments the antennas 227, 237 may be differently polarized. For example, the antenna 227 of the third sensor assembly 222 may be left hand polarized to communicate with one or more left hand polarized communication devices 50, while the antenna 237 of the fourth sensor assembly 232 may be right hand polarized to communicate with one or more right hand polarized communication devices 50. In one or more examples of embodiments, the identification portion 220 may operate independently of the sensor portion 110, for example, the identification portion 220 may operate or be powered on while the sensor portion 110 is not operating or powered down or off In addition, in one or more examples of embodiments, the third sensor assembly 222 may operate independently of the fourth sensor assembly 232, for example the third sensor assembly 222 may operate or be powered on while the fourth sensor assembly 232 is not operating or powered down or off

Referring to FIG. 10, the locator assembly 200 may include a computer system 140 connected to or attached to a portion of the control assembly 104. The computer system 140 may be in communication with or connected to the sensor portion 110 and/or identification portion 220. For example, the computer system 140 may be connected to one or more of the first sensor assembly 112, third sensor assembly 222, and/or fourth sensor assembly 232 by wireless connection, wired connection, or any other known or future developed communication connection.

FIG. 10A illustrates a partial cut-away elevation view of the locator assembly 200, taken from broken line 10A of FIG. 10. A portion of the fourth sensor assembly 232 is cut-away to illustrate a bearing or spherical member 235 connected to the connection assembly 233. The spherical member 235 may be received by a portion of the fourth sensor assembly 232. This allows the fourth sensor assembly to rotate about the spherical member 235.

In operation and use of the one or more examples of embodiments of the locator assembly 200 illustrated in FIGS. 10 and 10A, a user may use the locator assembly 200 to detect information associated with the magnetic field 12 of a buried object 10, enabling the user to ascertain the location of and/or locate the buried object 10. To this end, the user may proceed with the steps as substantially described herein in association with the locator assembly 100 and illustrated in FIG. 2 to detect and locate a buried object.

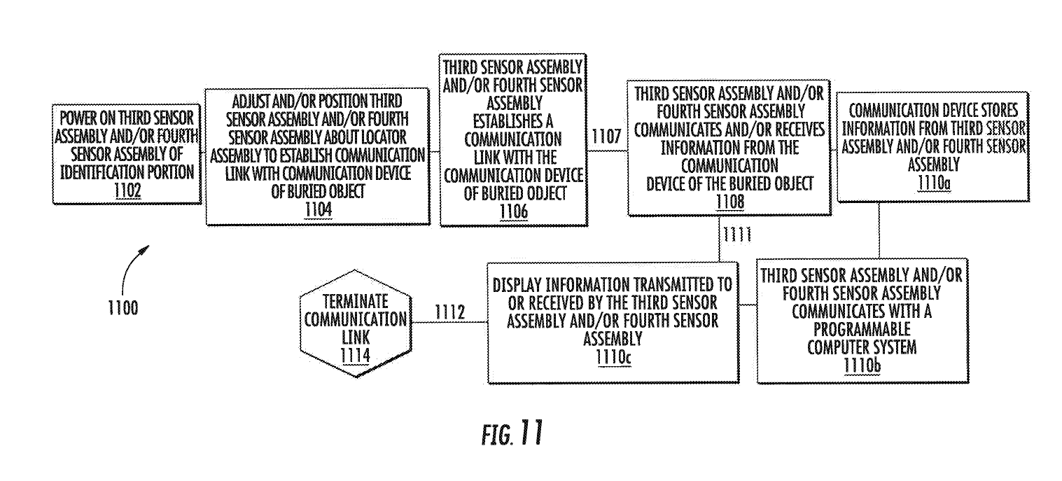

In addition, the user may use the locator assembly 200 illustrated in FIGS. 10 and 10A to identify and/or communicate with the buried object 10. FIG. 11 illustrates a method 1100 of using the identification portion 220 to identify and communicate with a buried object 10, which is depicted in flow chart or flow diagram form.

Referring to FIG. 11, the third sensor assembly 222 and/or fourth sensor assembly 232 may be activated or operated to communicate (e.g. send and/or receive information) with the communication device 50 of the buried object 10. At step 1102, the user may activate or trigger or switch on or power on the identification portion 220 and associated third sensor assembly or first RFID interrogator 222 and/or fourth sensor assembly or second RFID interrogator 232. In one or more examples of embodiments, in conjunction with the activation of the third sensor assembly 222 and/or fourth sensor assembly 232, the user may deactivate or switch off the first sensor assembly 112. For example, the first sensor assembly 112 may be interlocked to switch off upon activation of the third sensor assembly 222.

At step 1104, the user may adjust or position or reposition the first RFID interrogator 222 in order to establish a communication link with the RFID tag 50 of the buried object 10. For example, the user may rotate the first RFID interrogator 222 about spherical member 228 such that antenna 227 may establish a communication link with the buried object 10. In addition, the user may adjust or position or reposition the second RFID interrogator 232 in order to establish a communication link with the RFID tag 50 of buried object 10. For example, the user may pivot the second RFID interrogator 232 about pivot member 234 and/or rotate the second RFID interrogator 232 about spherical member 228 such that antenna 237 may establish a communication link with the RFID tag 50 of buried object 10.

At step 1106, the first RFID interrogator 222 and/or second RFID interrogator 232 may establish a communication link or information exchange link with the communication device 50 of buried object 10. At step 1107, the first RFID interrogator 222 and/or second RFID interrogator 232 may identify the communication device 50 of buried object 10. For example, the first RFID interrogator 222 and/or second RFID interrogator 232 may send to and/or receive a signal from the communication device 50 having identification information. If the buried object 10 is identified as the intended or targeted buried object, a user of the first RFID interrogator 222 and/or second RFID interrogator 232 may wish to send, receive or communicate additional information with the communication device 50 of buried object 10.

At step 1108, the first RFID interrogator 222 and/or second RFID interrogator 232 may communicate with the communication device 50. For example, the first RFID interrogator 222 and/or second RFID interrogator 232 may send a radio frequency (RF) signal to the buried object 10. The RFID tag 50 may receive the RF signal and in response, may transmit an RF signal back to the first RFID interrogator 222 and/or second RFID interrogator 232. The RF signal from the RFID tag 50 to the first RFID interrogator 222 and/or second RFID interrogator 232 may include information stored on the RFID tag 50. The information may include an identification number that identifies the specific RFID tag 50, and thus the specific buried object 10 associated with that RFID tag (e.g., a permanently locked alphanumeric number of a standard length), identifying information (e.g. location information, a serial number and/or a type code), a geographic position of the RFID tag 50 and/or the buried object 10 (e.g., GPS coordinates, latitude and longitude readings, and/or Public Land Survey System (PLSS) coordinates), information about the date the buried object 10 was placed, buried and/or updated, who placed the object, who last updated the information associated with the buried object 10, distances to other markers or points of interest (e.g., distance along a buried pipe until a split is reached), legal information (e.g. easement information or property boundaries in association with the property surrounding the buried object 10), and/or any other desired information. In one or more examples of embodiments, the information stored on the communication device or RFID tag 50 may be electronically locked or protected by password, for example to reduce or prevent counterfeiting, tampering, or alteration of information associated with the communication device or RFID tag 50. In one or more examples of embodiments, the first RFID interrogator 222 and/or second RFID interrogator 232 may exchange information with or acquire information from or transmit information to the communication device 50.

At step 1110a, the communication device 50 may store information communicated from or transmitted by the first RFID interrogator 222 and/or second RFID interrogator 232. For example, the RFID tag 50 may be able to receive information from the first RFID interrogator 222 and/or second RFID interrogator 232 and encode or save that information into a memory of the RFID tag 50.

At step 1110b, the first RFID interrogator 222 and/or second RFID interrogator 232 may transmit information to, receive information from, and/or be in communication with a programmable computer system 140 through a communication link (not shown). For example, the first RFID interrogator 222 and/or second RFID interrogator 232 may communicate with the programmable computer system 140 by wireless communication, such as, but not limited to, a cellular network (e.g. a mobile phone device) or a wireless interne connection, or by wired communication, such as, but not limited to, a Category 5 or Cat5 cable. In one or more examples of embodiments, the programmable computer system 140 may include a database or a machine-readable medium including instructions, which, when executed, cause the computer system 140 to perform operations. For example, the database may include information relating to the buried object 10, including, but not limited to, information regarding land rights (e.g. legal ownership or legal boundaries), GPS coordinates of the buried object 10, and/or known buried objects in the area around buried object 10. It should be appreciated that in one or more examples of embodiments, step 1110b may be performed in conjunction with step 1110a, or in the place of step 1110a.

At step 1110c, information transmitted to or received by the first RFID interrogator 222 and/or second RFID interrogator 232 may be displayed to the user. In one or more examples of embodiments, a screen or display 225 (e.g. an LED display) may be in communication with the first RFID interrogator 222 and/or second RFID interrogator 232 to display information received by the first RFID interrogator 222 and/or second RFID interrogator 232, for example, but not limited to, received from the communication device 50, computer system 140, or database associated with the computer system 140. In one or more examples of embodiments, the first RFID interrogator 222 and/or second RFID interrogator 232 may be in communication with the output device 124 to display information associated with the first RFID interrogator 222 and/or second RFID interrogator 232. Further, in one or more examples of embodiments, the information may be displayed to the user on a wireless device, for example, but not limited to a mobile phone device or computer system 140. It should be appreciated that in one or more examples of embodiments, step 1110c may be performed in conjunction with steps 1110a and/or 1110b, or in the place of steps 1110a and/or 1110b.

At step 1111, the user may subsequently transmit additional information to, receive additional information from, and/or be in additional communication with the communication device 50. To this end, the user may repeat one or more of steps 1108 through 1110.

At step 1112, the user may complete any and all communication with the communication device 50 of the buried object 10. To this end, at step 1114, the user may terminate or break the communication link between the first RFID interrogator 222 and/or second RFID interrogator 232 and communication device 50.

In addition, the user may use the locator assembly 200 illustrated in FIGS. 10 and 10A to determine the depth of the buried object 10. To this end, the user may proceed with the steps as substantially described herein in association with the locator assembly 200 and illustrated in FIG. 6 to ascertain or determine the depth 3 of the buried object 10.

In one or more examples of embodiments, the programmable computer system 140 disclosed herein may include random access memory (RAM), a computer readable storage medium or storage device or hard drive and a processor. In one or more examples of embodiments, the programmable computer system may be any known or future developed programmable computer processor system suitable to store data and operate in association with the locator assembly 100. Further, in one or more examples of embodiments, the computer readable storage medium may include any data storage device which can store data that can be thereafter read by a computer system. Examples of computer readable medium may include read-only memory, CD-ROM, CD-R, CD-RW, DVD, DVD-RW, magnetic tapes, Universal Serial Bus (USB) flash drive, or any other optical or other suitable data storage device. The computer readable medium may also be distributed over a network coupled or in communication with master computer system so that the computer readable code is stored and executed in a distributed fashion. In one or more examples of embodiments, the control assembly 104, sensor controller 106, sensor portion 110, and/or identification portion 220 may communicate with the programmable computer system 140 through wired communication, for example, but not limited to a Category 5 or Cat5 cable, through wireless communication, for example, but not limited to a wireless broadband or wireless communication, or through any other know or future developed communication methodology or system adapted to communicate information from the control assembly 104, sensor controller 106, sensor portion 110, and/or identification portion 220 to a programmable computer system 140.

There are several advantages to the disclosed locator assembly. The locator assembly provides for the detection, location and identification of a buried object. The buried object can be identified without requiring a line of sight between the user and the buried object, for example without digging down to or unearthing the buried object. Further, the buried object can advantageously be uniquely identified over other objects buried in an area. In addition, the locator assembly can ascertain the depth of a buried object. This advantageously provides information, which may include changes in the local environment of the buried object (for example, erosion, sediment deposit, or soil settling), or whether it is safe to dig to a desired depth (for example, determining the exact or approximate depth of a buried object can allow a determination to be made regarding the safety of digging above the buried object to the desired depth). In addition, the locator assembly provides for a single, handheld, transportable device for the detection, location and identification of a buried object. In addition, the locator assembly may be employed to verify that a user visited the site of one or more buried object. For example, the locator assembly may be used to keep a record of buried objects in which the locator assembly communicated with and/or read in order to verify that the user in fact actually visited the location of the buried object(s). As a further example, the locator assembly may be used for record keeping and/or verification of site visits, for examples, but not limited to, inspections (e.g. bridge inspections, tunnel inspections, parks and recreation site visits, and/or rail inspections), monitoring (e.g. darn monitoring, telephone pedestal monitoring, gas transmission monitoring), maintenance (e.g. elevator maintenance, traffic light maintenance and/or HVAC servicing), and/or record keeping (e.g. highway sign record keeping, forestry record keeping, and/or commodity record keeping). In addition, the locator assembly may be used in association with a patrol of pre-placed buried objects. For example, a user who is required to patrol one or more various locations (e.g., border patrol or security guards) may carry a portable or vehicle-mounted locator assembly that automatically interacts with buried objects (e.g. a check point monument) in the vicinity of the user and stores information obtained from those buried objects. After completing the required patrol route, the information can be used to verify that the user traveled through the required area patrol area, for example at a certain time or date. In addition, the locator assembly may be used in association with the location of underground utilities. For example, the underground utility may include one or more buried utility objects (for example, but not limited to, water pipes, natural gas pipes, electrical conduit, or sewage pipes) and may include a permanent magnet, may be made of a substantially metallic or ferrous content, or may include a communication device adapted to carry information. The information carried by the one or more communication devices may include one or more utility and/or geographic locations of the buried utility objects. The locator assembly may provide for the rapid pinpointing of the exact location of one or more buried utility objects. Further, the locator assembly may provide for the rapid identification and acquisition of information associated with one or more buried utility objects. Further, the locator assembly may communicate with a programmable computer system which may include a database. The locator assembly may transmit, receive or communicate information associated with the buried utility objects with the database. Further, the locator assembly may display information associated with the buried utility object and/or database to the user.

Aspects of the locator assembly 100, 200 described herein can be implemented on software running on a computer system. The system herein, therefore, may be operated by computer-executable instructions, such as program modules, executable on a computer. Program modules may include routines, programs, objects, components, data structures and the like which perform particular tasks or implement particular instructions. The software program may be operable for supporting the transfer of information within a network of trusted partner sites using artifacts.

The computers for use with the system and various components described herein may be programmable computers which may be special purpose computers or general purpose computers that execute the system according to the relevant instructions. The computer system can be an embedded system, a personal computer, notebook computer, server computer, mainframe, networked computer, handheld computer, personal digital assistant, workstation, and the like. Other computer system configurations may also be acceptable, including, cell phones, mobile devices, multiprocessor systems, microprocessor-based or programmable electronics, network PC's, minicomputers, and the like. Preferably, the computing system chosen includes a processor suitable in size to efficiently operate one or more of the various systems or functions.

The system or portions thereof may also be linked to a distributed computing environment, where tasks are performed by remote processing devices that are linked through a communications network. To this end, the system may be configured or linked to multiple computers in a network, including, but not limited to a local area network, a wide area network, a wireless network; and the Internet. Therefore, information and data may be transferred within the network or system by wireless means, by hardwire connection or combinations thereof.

The computer can also include a display, provision for data input and output, etc. Furthermore, the computer or computers may be operatively or functionally connected to one or more mass storage devices, such as, but not limited to a database. The memory storage can be volatile or non-volatile and can include removable storage media. The system may also include computer-readable media which may include any computer readable media or medium that may be used to carry or store desired program code that may be accessed by a computer. The invention can also be embodied as computer readable code on a computer readable medium. To this end, the computer readable medium may be any data storage device that can store data which can be thereafter read by a computer system. Examples of computer readable medium include read-only memory, random-access memory, CD-ROM, CD-R, CD-RW, magnetic tapes, and other optical data storage devices. The computer readable medium can also be distributed over a network coupled computer system so that the computer readable code is stored and executed in a distributed fashion.

Although various representative examples of embodiments of this invention have been described above with a certain degree of particularity, those skilled in the art could make numerous alterations to the disclosed embodiments without departing from the spirit or scope of the inventive subject matter set forth in the specification and claims. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Moreover, some portions of the detailed descriptions herein are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities. Unless specifically stated otherwise as apparent from the discussions herein, it is appreciated that throughout the present invention, discussions utilizing terms such as “receiving,” “sending,” “generating,” “reading,” “invoking,” “selecting,” and the like, refer to the action and processes of a computer system, or similar electronic computing device, including an embedded system, that manipulates and transforms data represented as physical (electronic) quantities within the computer system.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g., attached, coupled, connected) arc to be construed broadly and may include intermediate members between a connection of elements and relative movement between elements. As such, joinder references do not necessarily infer that two elements are directly connected and in fixed relation to each other. In some. instances, in methodologies directly or indirectly set forth herein_{;} various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to certain embodiments, persons skilled in the art will recognize that changes may be made in form and detail without departing from the spirit and scope of the invention.

What is claimed is:

1. A locator assembly for the detection, location and identification of a buried object comprising:
a sensor portion adapted to detect and measure the magnetic field strength of a buried object;
a control assembly connected to the sensor portion, wherein the control assembly is adapted to receive and analyze the magnetic field strength provided by the sensor portion to ascertain the location of the buried object; and
an identification portion in communication with the control assembly and which operates independently of the sensor portion, wherein the identification portion is adapted to communicate with the buried object to ascertain the identity of the buried. object.

2. The locator assembly of claim 1, wherein the sensor portion includes a first sensor and a second sensor.

3. The locator assembly of claim 2, further comprising a wand assembly connected to the control assembly, wherein the first and second sensors are connected to the wand assembly.

4. The locator assembly of claim 3, wherein the first and second sensors are received within the wand assembly.

5. The locator assembly of claim 2, wherein the sensor portion includes a third sensor and a fourth sensor.

6. The locator assembly of claim 5, wherein the third and fourth sensors are in communication, the first and second sensors are in communication, and the third and fourth sensors are independent from the first and second sensors.

7. The locator assembly of claim 6, wherein the third and fourth sensors are respectively provided perpendicular to the first and second sensors.

8. The locator assembly of claim 1, wherein the buried object includes a communication device adapted to communicate with the identification portion.

9. The locator assembly of claim 8, wherein the communication device includes an RFID tag.

10. The locator assembly of claim 9, wherein the identification portion includes an RFID interrogator having an antenna.

11. The locator assembly of claim 10, wherein the antenna is a helical antenna.

12. The locator assembly of claim 11, further comprising a wand assembly connected to the control assembly, wherein the helical antenna wraps about a portion of the wand assembly.

13. A method of detecting, locating and identifying a buried object comprising:
detecting a magnetic field of a buried object about a portion of a surface of a ground with a sensor portion of a locator assembly;
measuring the magnetic field strength of the magnetic field of the buried object with a locator assembly;
locating the buried object below a portion of the surface of the ground;
communicating with the buried object with an RFID interrogator; and
receiving information from an RFD to attached to the buried object, including the identity of the buried object.

14. The method of claim 13, wherein the RFID interrogator is connected to the locator assembly.

15. The method of claim 13 further comprising:
transmitting a first signal from the RFID interrogator to the RFID tag attached to the buried object;
receiving a second signal with the RFID interrogator from the RFID tag; and
analyzing the first signal and second signal to ascertain the depth of the buried object.

16. A method of detecting, locating and identifying a buried object comprising:
detecting information associated with a buried object about a portion of a surface of a ground with a sensor portion of a locator assembly;
measuring the information associated with the buried object with a locator assembly;
locating the buried object below a portion of the surface of the ground;
interrogating the buried object with a first signal transmitted from an RFID interrogator; and
receiving a second signal from an RFID tag attached to the buried object, wherein the second signal includes information including the identity of the buried object.

17. The method of claim 16 further comprising:
transmitting information from the RFID interrogator to the RFID tag attached to the buried object; and
storing the information from the RFID interrogator on the RFID tag attached to the buried object.

18. The method of claim 16, wherein the information associated with the buried object in the detecting step includes information associated with a magnetic field.

19. The method of claim 16, wherein the information associated with the buried object in the measuring step includes a magnetic field strength of a magnetic field emanating from the buried object.

20. The method of claim 16 further comprising:
analyzing the first signal and second signal to ascertain the depth of the buried object.
